(19) United States
(12) Patent Application Publication
(10) Pub. No.: US 2011/0210610 A1
(43) Pub. Date: Sep. 1, 2011

(54) PHOTOVOLTAIC POWER GENERATION SYSTEM

(76) Inventors: Hirofumi Mitsuoka, Osaka (JP); Masami Kurosawa, Osaka (JP)

(21) Appl. No.: 13/127,111

(22) PCT Filed: Oct. 6, 2009
(86) PCT No.: PCT/JP2009/067372

§ 371 Date: May 2, 2011

(30) Foreign Application Priority Data
Nov. 4, 2008 (JP) 2008-283485

(51) Int. Cl. H02J 1/10

(52) U.S. Cl. 307/51; 307/43

(57) ABSTRACT

A photovoltaic power generation system includes: a plurality of units, each of the units being formed with a string, which is a series-connection body of a plurality of solar cell modules, or with a solar cell module; a plurality of connection cables to which the units are each connected such that the units are parallelly connected to each other; a junction box to which each end of the plurality of connection cables is connected; and a failure detection section that performs failure detection and outputs a detection result on a unit-by-unit basis, the failure detection section being located outside the junction box.

### TECHNICAL FIELD

The present invention is related to a photovoltaic power generation system, and specifically relates to a photovoltaic power generation system capable of detecting a failure.

### BACKGROUND ART

In a typical photovoltaic power generation system, direct-current power is generated by a solar cell array formed by parallelly connecting a plurality of series-connected bodies (strings) each of which is composed of a plurality of series-connected solar cell modules, the direct current electric power is converted to alternating-current power by, for example, an inverter device, and the alternating-current power is supplied to a commercial power network.

In a photovoltaic power generation system employing a solar cell module providing a low-voltage output (for example, a crystalline silicon solar cell module having an open voltage of on the order of 20 V), an increased number of solar cell modules are series-connected to each other such that the open voltage of a solar cell string (that is, the total of the open voltages of the series-connected solar cell modules) reaches the lower limit of a predetermined range. On the other hand, in a photovoltaic power generation system employing a solar cell module providing a high-voltage output (for example, a thin film solar cell module having an open voltage of 240 V or higher), a reduced number of solar cell modules are series-connected to each other such that the open voltage of a solar cell string does not exceed the upper limit of a predetermined range. Another possible structure for a photovoltaic power generation system employing a solar cell module providing a high-voltage output is one in which, instead of solar cell strings, a plurality of individual solar cell modules are parallelly connected to each other to form a solar cell array such that the open voltage of the solar cell modules does not exceed the upper limit of a predetermined range. The predetermined range is set according to the specification of an inverter device.

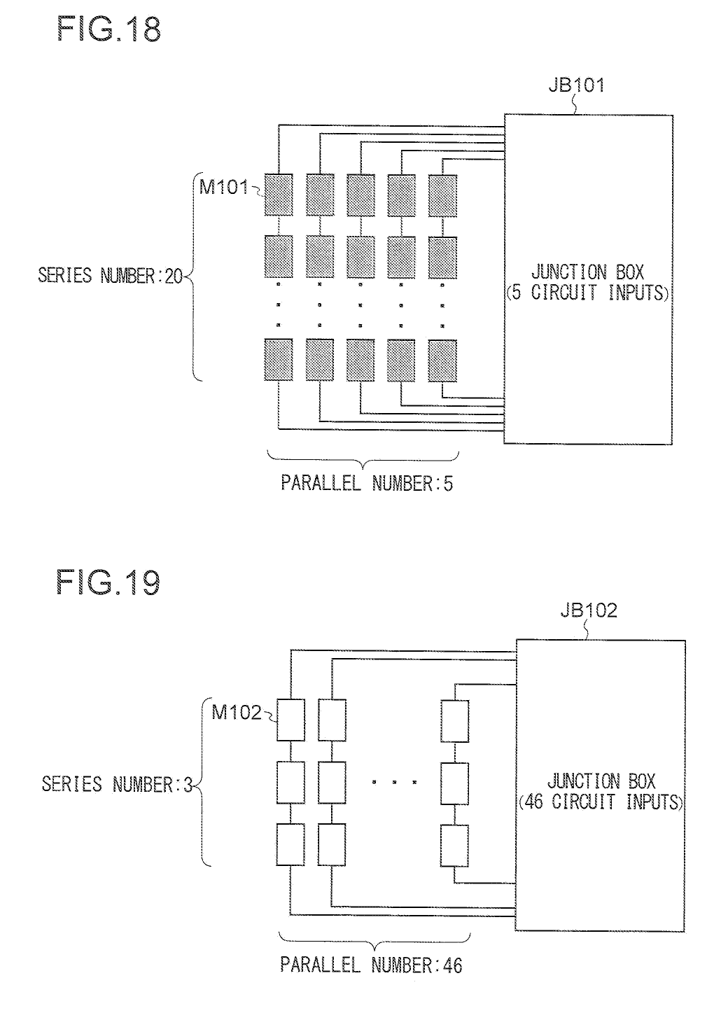

For example, a solar cell array having a maximum output of 16.7 kW can be built with low-voltage-output solar cell modules each having a maximum output of 167 W, as shown in FIG. 18, by setting the number of the low-voltage-output solar cell modules M101 in a series connection to 20, setting the number of strings of the 20 low-voltage-output solar cell modules M101 in a parallel connection to five, and connecting the strings each to a junction box JB101 that has five circuit inputs.

For another example, a solar cell array having a maximum output of 16.7 kW can be built with high-voltage-output solar cell modules each having a maximum output of 121 W, as shown in FIG. 19, by setting the number of the high-voltage-output solar cell modules M102 in a series connection to three, setting the number of strings of the three high-voltage-output solar cell modules M102 in a parallel connection to 46, and connecting the strings each to a junction box JB102 that has 46 circuit inputs.

However, with the structure shown in FIG. 19, since the number of the high-voltage-output solar cell modules M102 in the parallel connection is large, the distance between the junction box JB102 and a string located far away from the junction box JB102 is so long that it is difficult to route a cable, and furthermore, a large number of cables are required. This makes the structure shown in FIG. 19 disadvantageous in terms of workability.

### CITATION LIST

### Patent Literature

Patent Literature 1: JP-A-H08-317675

Patent Literature 2: JP-A-2003-23171

Patent Literature 3: JP-A-2005-44824

Patent Literature 4: JP-A-2000-269531

### SUMMARY OF INVENTION

### Technical Problem

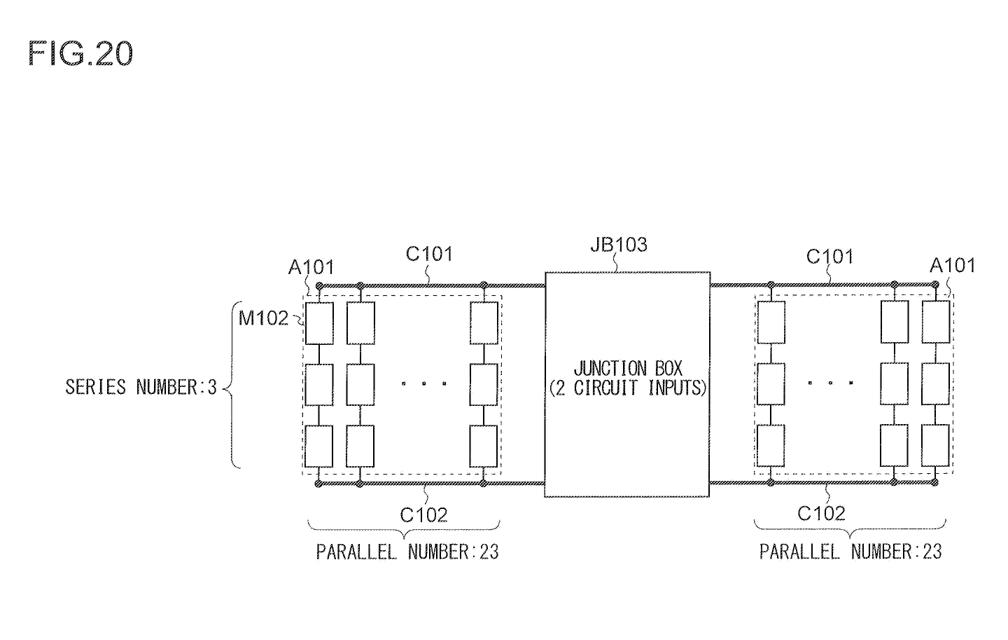

A possible way to solve the disadvantage in workability as described above is to adopt connection cables (a first connection cable provided with a first common line C101 to which one end of each string is connected, and a second connection cable provided with a second common line C102 to which the other end of each string is connected) to achieve a structure as shown in FIG. 20. In the structure shown in FIG. 20, the number of cables is significantly reduced compared with in the structure shown in FIG. 19, and thus the junction box in this structure can be a simple junction box (a junction box JB103) having two circuit inputs. Thus, workability is significantly improved compared with the structure shown in FIG. 19.

However, the structure as shown in FIG. 20 suffers from a disadvantage that it is impossible, or difficult, to perform failure detection on a string-by-string basis.

With the structure shown in FIG. 18, since the strings correspond to the circuit inputs of the junction box JB101 on a one-to-one basis, it is possible to detect failures on a string-by-string basis by using a tester or the like in the junction box JB101 to measure voltage or current with respect to each of the circuit inputs. With the structure shown in FIG. 19, string-by-string failure detection can be performed in the same manner as in the structure shown in FIG. 18.

In contrast, with the structure shown in FIG. 20, the strings do not correspond to the circuit inputs of the junction box JB103 on a one-to-one basis, and thus, even if a tester or the like is used in the junction box JB103 to measure voltage or current at each of the circuit inputs, failure detection can be performed with respect to the solar cell arrays A101 only on an array-by-array basis. With the structure shown in FIG. 20, measurement needs to be performed at locations where the strings are arranged to perform failure detection on a string-by-string basis, and this is enormously troublesome.

As discussed above, in a possible system structure for a photovoltaic power generation system employing a high-voltage-output solar cell module, a solar cell array is formed by parallelly connecting not strings of solar cell modules but a plurality of individual solar cell modules to each other, and the open voltage of the solar cell modules is set so as not to exceed the upper limit of a predetermined range; however, even this system structure has a disadvantage that failure detection cannot be performed on a module-by-module basis or a disadvantage that failure detection is difficult to be performed on a string-by-string basis.

Patent Literatures 1 to 4 propose various technologies related to failure detection in photovoltaic power generation systems, but disadvantageously, none of Patent Literatures 1 to 4 teaches a structure capable of avoiding waste in the routing of conductors and the like in parallelly connecting a plurality of units each formed with a string, which is a series-connection body of a plurality of solar cell modules, or a solar cell module.

The present invention has been made in view of the foregoing, and an object of the present invention is to provide a photovoltaic power generation system that includes a plurality of units each of which is a string, which is a series-connection body of a plurality of solar cell modules, or a solar cell module, that is capable of avoiding waste in the routing of conductors and the like in parallelly connecting the plurality of units, and that is capable of performing failure detection on a unit-by-unit basis.

### Solution to Problem

To achieve the above object, according to the present invention, a photovoltaic power generation system is provided with: a plurality of units, each of the units being formed with a string, which is a series-connection body of a plurality of solar cell modules, or with a solar cell module; a plurality of connection cables to which the units are each connected such that the units are parallelly connected to each other; and a failure detection section that performs failure detection and outputs a detection result on a unit-by-unit basis.

The photovoltaic power generation system according to the present invention may be structured such that one of the plurality of connection cables is a first connection cable provided with a first common line to which one end of each of the plurality of units is connected, such that another of the plurality of connection cables is a second connection cable provided with a second common line to which another end of each of the units is connected, and such that the failure detection section is located between a first connection section and a second connection section, the first connection section being a section at which a unit of the units is connected to the first common line, and the second connection section being a section at which a unit of the units is connected to the second common line.

From a view point of preventing an overcurrent from flowing in a unit when the unit has become a load, the photovoltaic power generation system according to the present invention may be structured such that a blocking diode is provided between the first common line and a unit of the units.

The photovoltaic power generation system according to the present invention may be structured such that there is provided a divergence section that diverges from the first common line to be connected to one end of a unit of the units and the blocking diode is arranged in the divergence section.

The photovoltaic power generation system according to the present invention may be structured such that there is provided a divergence section that diverges from the first common line to be connected to one end of a unit of the units and the failure detection section is arranged in the divergence section.

The photovoltaic power generation system according to the present invention may be structured such that at least part of the divergence section is replaceable.

### Advantageous Effects of Invention

According to the structure of the present invention, since the photovoltaic power generation system includes a plurality of connection cables to which the units are each connected such that the units are parallelly connected to each other, it is possible to avoid waste in the routing of conductors and the like in parallelly connecting the plurality of units, and furthermore, since a failure detection section that performs failure detection and outputs a detection result on a unit-by-unit basis is provided, failure detection can be performed with respect to the units on a unit-by-unit basis.

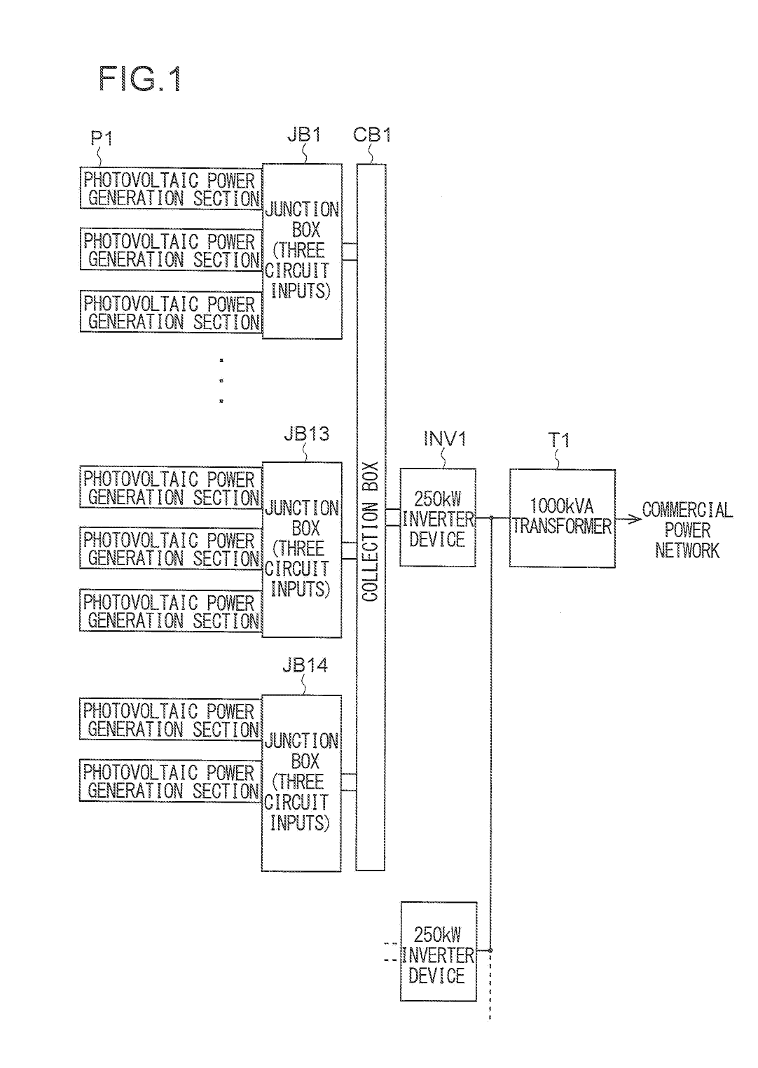

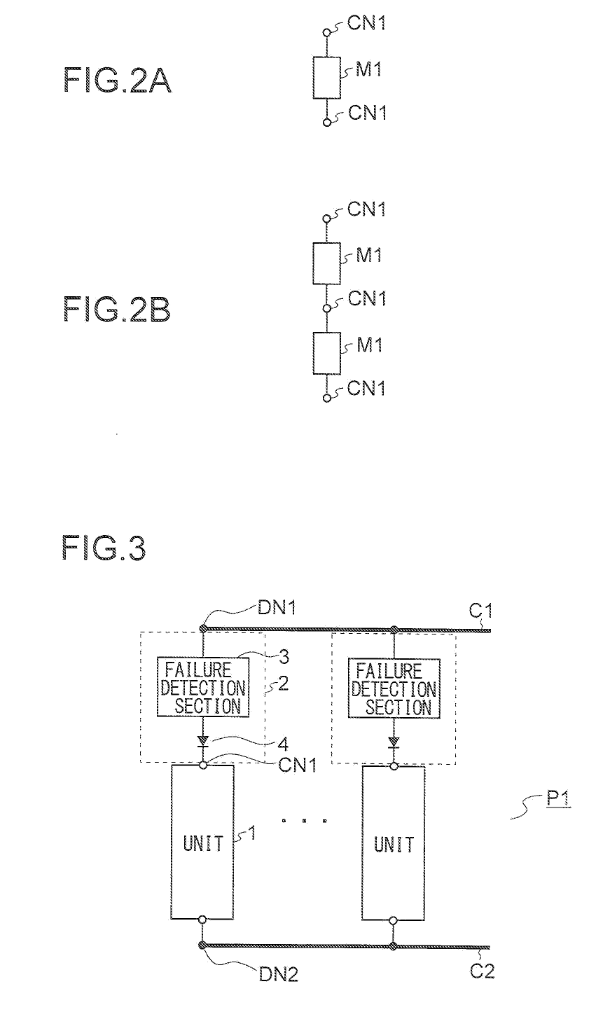

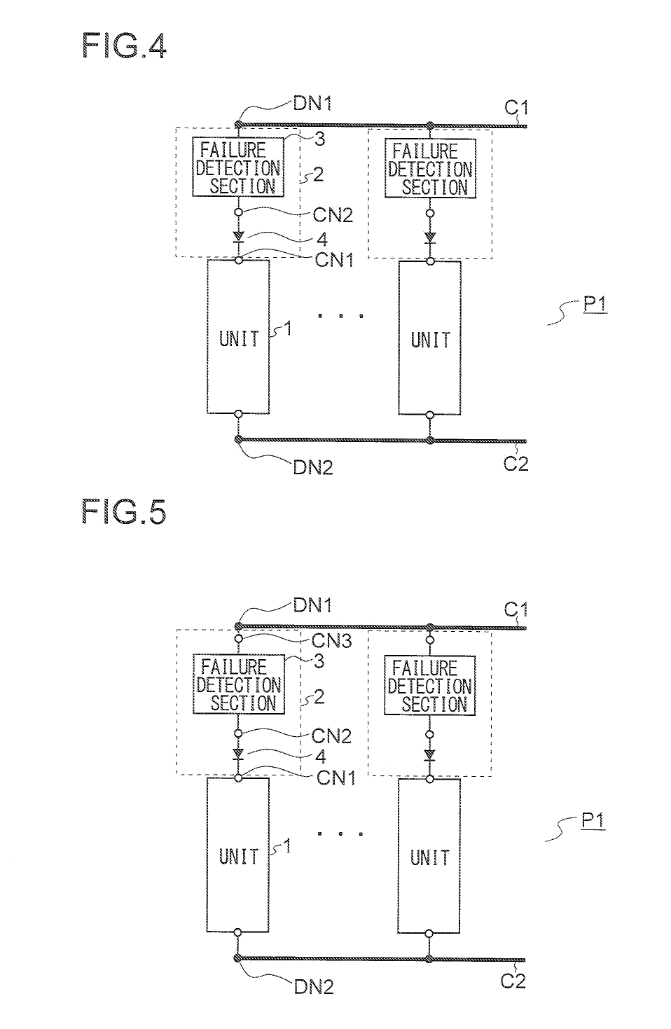

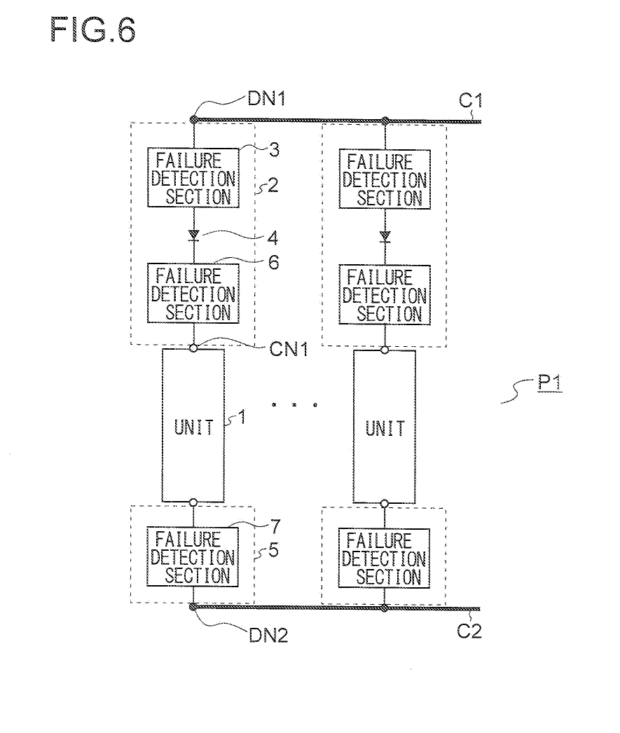

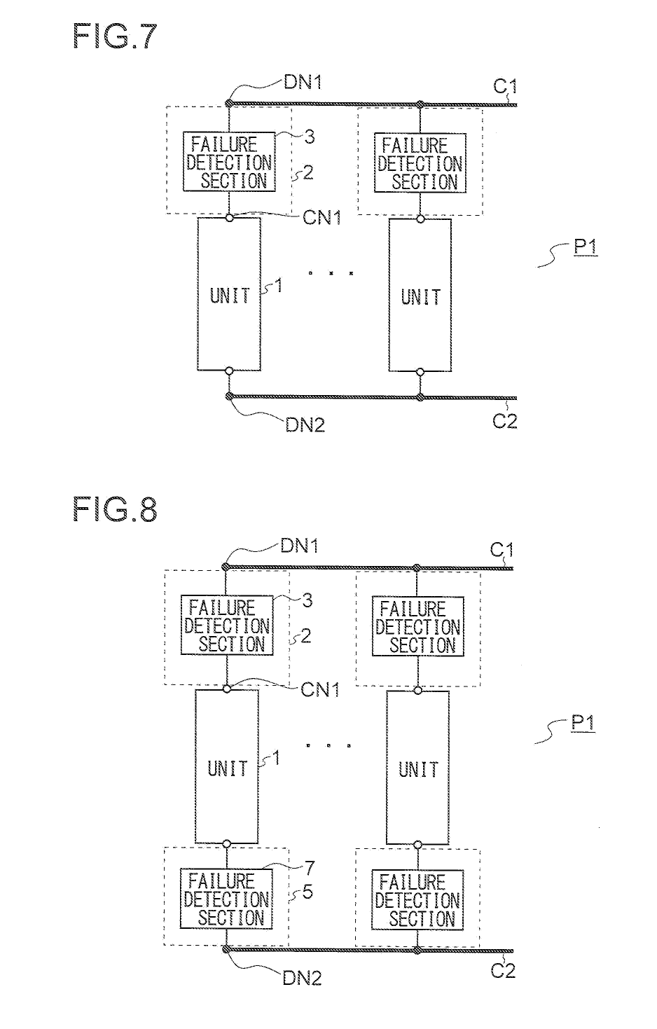

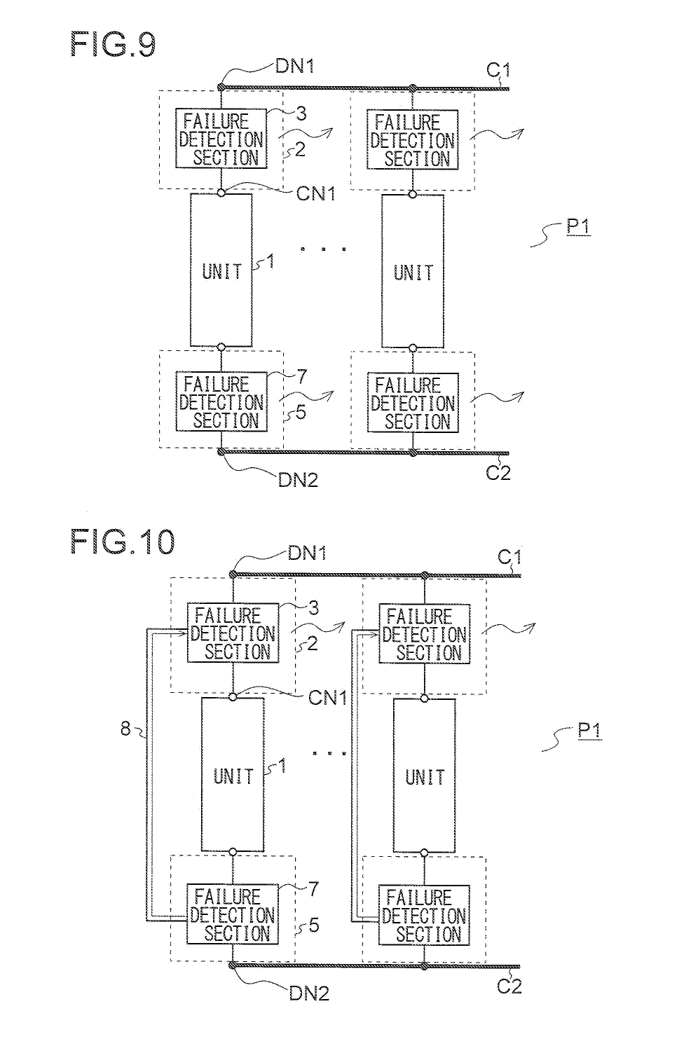

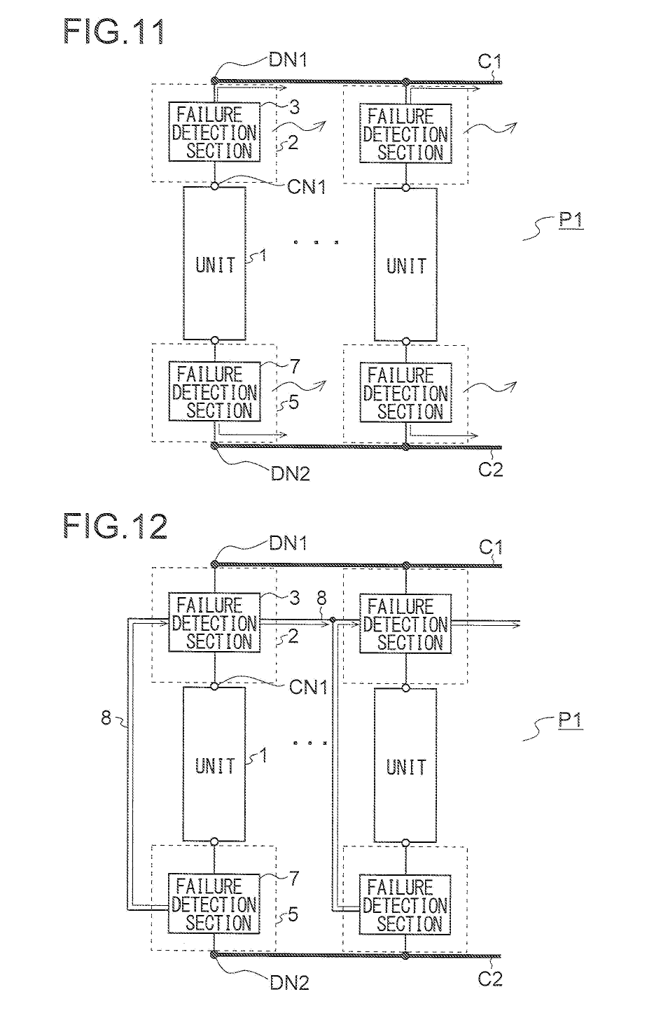

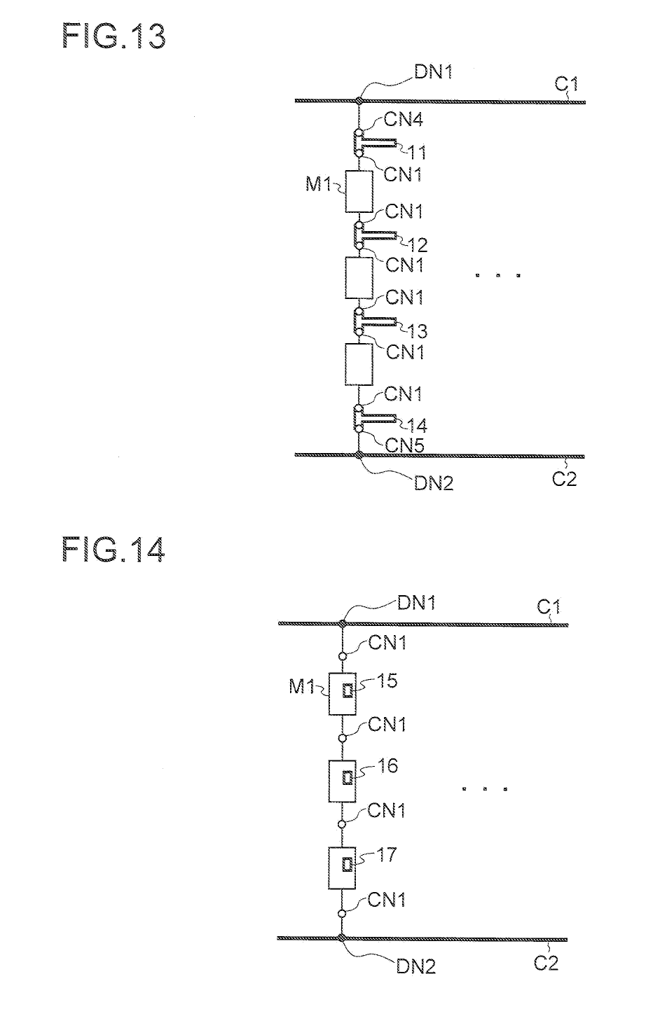

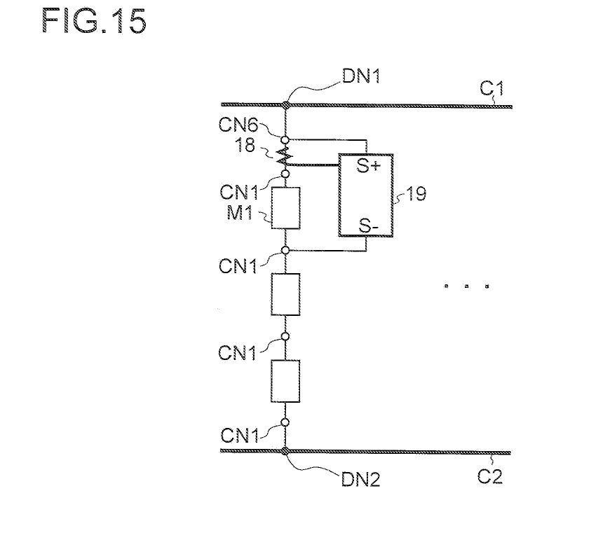

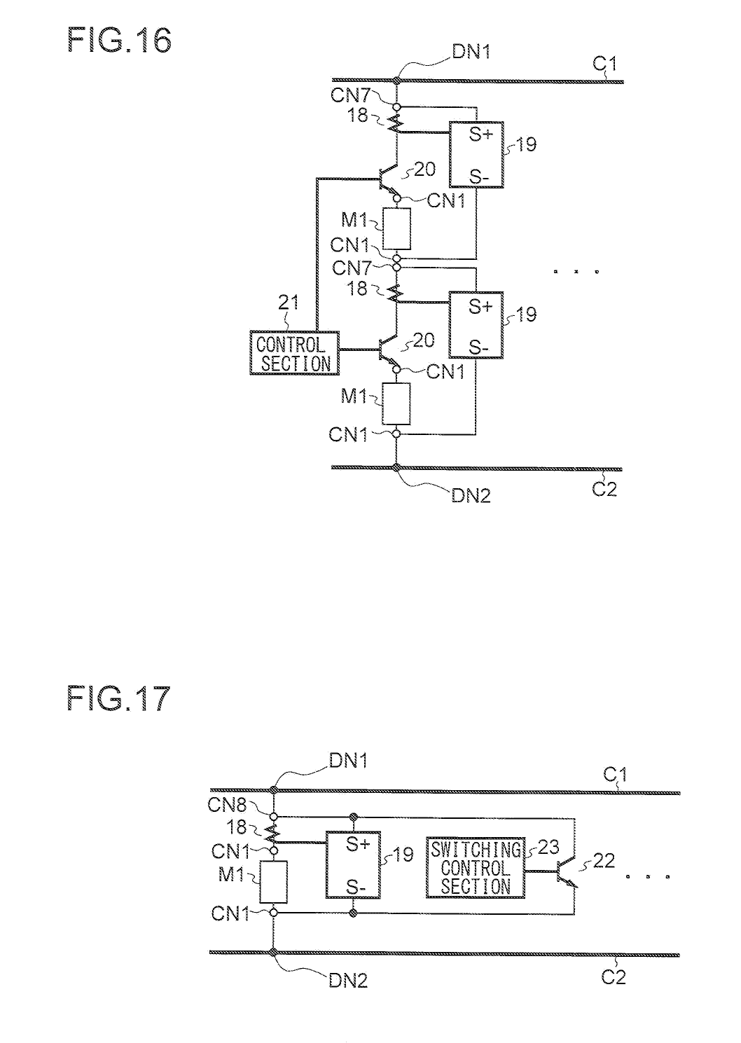

### BRIEF DESCRIPTION OF DRAWINGS

[FIG. 1] A diagram showing an example of the overall structure of a photovoltaic power generation system according to the present invention;

[FIG. 2A] A diagram showing an example of the structure of a unit;

[FIG. 2B] A diagram showing an example of the structure of a unit;

[FIG. 3] A diagram showing an example of the structure of a photovoltaic power generation section;

[FIG. 4] A diagram showing an example of the structure of a photovoltaic power generation section;

[FIG. 5] A diagram showing an example of the structure of a photovoltaic power generation section;

[FIG. 6] A diagram showing an example of the structure of a photovoltaic power generation section;

[FIG. 7] A diagram showing an example of the structure of a photovoltaic power generation section;

[FIG. 8] A diagram showing an example of the structure of a photovoltaic power generation section;

[FIG. 9] A diagram showing an example of information transmission performed in the photovoltaic power generation section shown in FIG. 8;

[FIG. 10] A diagram showing an example of information transmission performed in the photovoltaic power generation section shown in FIG. 8;

[FIG. 11] A diagram showing an example of information transmission performed in the photovoltaic power generation section shown in FIG. 8;

[FIG. 12] A diagram showing an example of information transmission performed in the photovoltaic power generation section shown in FIG. 8;

[FIG. 13] A diagram showing an arrangement example in which failure detection sections that perform wireless communication are arranged such that failures of the solar cell modules can be detected on a module-by-module basis;

[FIG. 14] A diagram showing an arrangement example in which failure detection sections that perform wireless communication are arranged such that failures of solar cell modules can be detected on a module-by-module basis;

[FIG. 15] A diagram showing an arrangement example in which a failure detection section that performs power line communication is connected to both ends of a solar cell module;

[FIG. 16] A diagram showing another arrangement example in which a failure detection section that performs power line communication is connected to both ends of a solar cell module;

[FIG. 17] A diagram showing still another arrangement example in which a failure detection section that performs power line communication is connected to both ends of a solar cell module;

[FIG. 18] A diagram showing the connection relationship between low-voltage-output solar cell modules and a junction box;

[FIG. 19] A diagram showing the connection relationship between high-voltage-output solar cell modules and a junction box; and

[FIG. 20] A diagram showing the connection relationship between high-voltage-output solar cell modules and a junction box in a case where a connection cable is used.

### DESCRIPTION OF EMBODIMENTS

Hereinafter, a description will be given of an embodiment of the present invention with reference to the drawings. An example of the overall structure of a photovoltaic power generation system according to the present invention is shown in FIG. 1. The photovoltaic power generation system shown in FIG. 1 is an industrial photovoltaic power generation system of 10 kW or more, and the system includes a plurality of blocks each including: junction boxes JB1 to JB13 each having three circuit inputs and each having three photovoltaic power generation sections P1 connected thereto; a junction box JB14 having three circuit inputs and having two photovoltaic power generation sections P1 connected thereto; a collection box CB1 having 14 circuit inputs and having the junction boxes JB1 to JB14 connected thereto; and an inverter device INV1 that has a maximum output of 250 kW and converts direct-current power supplied from the collection box CB1 to alternating-current power. The photovoltaic power generation system further includes a transformer T1 with rated capacity of 1000 kVA that receives the alternating-current power outputted from the inverter device INV1 of each of the blocks, transforms the voltage of the total of the received alternating-current power, and supplies the resulting alternating-current power to a commercial power network. The junction box JB14 has three circuit inputs, two of which are used and a third of which is not used. In the photovoltaic power generation system shown in FIG. 1, it is not necessary that all the photovoltaic power generation sections P1 have the same structure; a photovoltaic power generation section P1 having a different structure may be included.

Hereinafter, a description will be given of the photovoltaic power generation section P1, which characterizes the present invention. The photovoltaic power generation section P1 includes a plurality of units. A unit is either a solar cell module M1 as shown in FIG. 2A or a string, which is a series-connection body of a plurality of solar cell modules M1 as shown in FIG. 2B. Incidentally, FIG. 2B illustrates a unit including two series-connected solar cell modules M1 as an example, but this is not meant as a limitation, and the number of solar cell modules M1 to be series-connected in a unit is determined based on the specification of the inverter device INV1 such that the open voltage of the unit is within a predetermined range. Each of the solar cell modules M1 is attachable/detachable with respect to a connection destination at a connection point CN1. The connection point CN1 can be achieved by, for example, a connector.

An advantage of the present invention is that waste in the routing of conductors and the like can be avoided in parallelly connecting the plurality of units, and this advantage is remarkable particularly in a case in which a high-voltage-output solar cell module (for example, a thin film solar cell module having an open voltage of 240 V or higher) is used as the solar cell module M1, an increased number of solar cell modules being parallelly connected in this case. However, even in a case where a low-voltage-output solar cell module (for example, a crystalline silicon solar cell module having an open voltage of on the order of 20 V) is used as the solar cell module M1, the advantage of the present invention that waste in the routing of conductors and the like can be avoided in parallelly connecting the plurality of units can be obtained. Thus, the solar cell module M1 may be either one of a high-voltage-output solar cell module and a low-voltage-output solar cell module.

Next, examples of the structure of the photovoltaic power generation section P1 are shown in FIGS. 3 to 8. In FIGS. 3 to 8, there is no particular limitation to the number of units in a parallel connection, and the number is determined according to the maximum output of the unit and the number of units in a series connection.

First, a description will be given of the photovoltaic power generation section P1 having the structure shown in FIG. 3. In the photovoltaic power generation section P1 structured as shown in FIG. 3, one end of each of units 1 is connected, via a divergence section 2, to a first common line C1 of a first connection cable, and the other end of each of the units 1 is connected to a second common line C2 of a second connection cable. The divergence section 2 diverges from the first common line C1 at a divergence point DN1, which is a first connection section, and in the example shown in FIG. 3, the divergence section 2 is not detachable/attachable with respect to the first common line C1 at the divergence point DN1. In the example shown in FIG. 3, a divergence point DN2 which is provided along the second common line C2 of the second connection cable as a second connection section is not a detachable/attachable point just like the divergence point DN1 is not a detachable/attachable point. In the photovoltaic section P1 used in the photovoltaic power generation system shown in FIG. 1, it is advisable that a first connection cable has, for example, 25 divergence points DN1, and that a second connection cable has 25 divergence points DN2.

In the photovoltaic power generation section P1 shown in FIG. 3, the divergence sections 2 each include a failure detection section 3 and a blocking diode 4.

Here, a description will be given of a reason why it is preferable that each unit include a blocking diode 4. A discussion will be given of a case where the solar cell modules are irradiated with solar light. When an inverter device is operating, power generated by the solar cell modules is forcibly outputted to the commercial power network. On the other hand, when the inverter device stops operating for some reason (for example, abnormal voltage of the commercial power network), any solar cell module having no burden imposed thereon falls into an open voltage state, and no current flows therein. However, if a solar cell module bears a burden (such as degradation of the module, shade, and unevenness in module property), when the inverter device stops operating, a reverse current rushes through the unit including the solar cell module bearing the burden, and thus an overcurrent flows through the unit bearing the burden. The overcurrent can be avoided by providing a blocking diode in each of the units.

Next, a description will be given of the photovoltaic power generation section P1 structured as shown in FIG. 4. The photovoltaic power generation section P1 shown in FIG. 4 has the same structure as shown in FIG. 3 except that a connection point CN2 is additionally provided between the failure detection section 3 and the blocking diode 4. This results in a structure where the connection point CN1 is provided at one end of the blocking diode 4 and the connection point CN2 is provided at the other end of the blocking diode 4; with this structure, the blocking diode 4 is detachable/attachable with respect to the unit 1 and the failure detection section 3, and this makes the blocking diode 4 replaceable.

Next, a description will be given of the photovoltaic power generation section P1 structured as shown in FIG. 5. The photovoltaic power generation section P1 shown in FIG. 5 has the same structure as shown in FIG. 4 except that a connection point CN3 is additionally provided between the divergence point DN1, which is a first connection section, and the failure detection section 3. This results in a structure where the connection point CN2 is provided at one end of the failure detection section 3 and the connection point CN3 is provided at the other end of the failure detection section 3; with this structure, the failure detection section 3 is detachable/attachable with respect to the first common line C1 and the blocking diode 4, and this makes it possible to replace the failure detection section 3. Here, the failure detection section 3, the blocking diode 4, and the unit 1 are arranged in this order from the divergence point DN1 side to the divergence point DN2 side, but the failure detection section 3, the blocking diode 4, and the unit 1 may be replaced with each other to be arranged in a different order.

Next, a description will be given of the photovoltaic power generation section P1 structured as shown in FIG. 6. In the photovoltaic power generation section P1 structured as shown in FIG. 6, one end of each of units 1 is connected, via a divergence section 2, to a first common line C1 of a first connection cable, and the other end of each of the units 1 is connected, via a divergence section 5, to a second common line C2 of a second connection cable. The divergence section 2 diverges from the first common line C1 at a divergence point DN1, which is a first connection section, and in the example shown in FIG. 6, the divergence section 2 is not detachable/attachable with respect to the first common line C1 at the divergence point DN1. Furthermore, a divergence section 5 diverges from a second common line C2 at a divergence point DN2, which is a second connection section, and in the example shown in FIG. 6, the divergence section 5 is not detachable/attachable with respect to the second common line C2 at the divergence point DN2.

Moreover, in the photovoltaic power generation section P1 structured as shown in FIG. 6, the divergence section 2 includes a blocking diode 4, a failure detection section 3 provided on the anode side of the blocking diode 4, and a failure detection section 6 provided on the cathode side of the blocking diode 4, and the divergence section 5 includes a failure detection section 7.

Next, a description will be given of the photovoltaic power generation section P1 structured as shown in FIG. 7. The photovoltaic power generation section P1 shown in FIG. 7 has the same structure as shown in FIG. 4 except that the blocking diode 4 is omitted.

Next, a description will be given of the photovoltaic power generation section P1 structured as shown in FIG. 8. The photovoltaic power generation section P1 shown in FIG. 8 has the same structure as shown in FIG. 6 except that the blocking diode 4 and the failure detection section 6 are omitted.

In the above-described structures shown in FIGS. 3 to 8, it is advisable, for example, that the failure detection section 3 detects a current flowing in the unit 1 and detects occurrence of an open failure while power is being generated. It is advisable, for example, that different voltages are applied to the two lines from an inverter, etc. via the first common line C1 and the second common line C2, and whether or not a current flows is detected by each of the failure detection sections to detect whether or not an open failure has occurred.

In the structure shown in FIG. 6 or 8, it is advisable, for example, that the failure detection sections 3, 6 and 7 are each provided with a voltage application function and a function of detecting a current flowing in the unit 1, such that detection of an open failure is performed by applying different voltages to the two ends of the unit 1 or to the two ends of the blocking diode 4 at night and checking whether a current flows between the two ends. In this case, it is judged that no open failure has occurred when current is found to be flowing between the two ends, while it is judged that an open failure has occurred when no current is found to be flowing between the two ends.

Furthermore, in the structures shown in FIGS. 6 and 8, for example, the failure detection sections 3, 6 and 7 may each be provided with a voltage application function and a function to detect a current that flows in the unit 1, such that detection of a failure is performed by constantly applying different voltages to the two ends of the unit 1 or to the two ends of the blocking diode 4 at night and by checking a change in current flowing between the two ends.

In a case where failure detection is performed in the daytime, the above-described failure detection sections can use, for example, power generated by the unit 1 as its power. In a case where failure detection is performed at night, if, for example, the inverter device INV1 (see FIG. 1) is capable of performing both DC-to-AC conversion and AC-to-DC conversion, power from the commercial power network can be used as power for the above-described failure detection sections. An inverter device, battery, etc. may be provided in the junction boxes JB1 to JB14 and the collection box CB1 (see FIG. 1) to be used exclusively as power supply for the above-described failure detection sections. In a case where the above-described failure detection sections carry out wireless communication, the power for the failure detection sections may be secured by wireless power supply. Since wireless communication is low-power communication in comparison with wire communication such as power line communication, a compact and low-cost power supply can be easily achieved.

The above-described failure detection sections communicate with a failure monitoring section by wireless communication or wire communication. A failure monitoring section may be provided for each photovoltaic power generation system. Alternatively, a failure monitoring section may be shared by a plurality of photovoltaic power generation systems such that the failure monitoring section covers the plurality of photovoltaic power generation system.

Furthermore, when the failure monitoring section receives a signal related to a result of the failure detection to the effect that a failure has been detected, the failure monitoring section may send an instruction to instruct the source of the signal to set more advanced settings. In this case, if the failure monitoring section has received ID information (identification data), the instruction can be sent more easily.

In the case where the above-described failure detection sections performs wireless communication, there may be provided a receiving antenna for receiving an RF signal transmitted from the failure detection sections, the receiving antenna being connected by a wire to the failure monitoring section. This makes it easy to deal with a case where the communicable distance of wireless communication is comparatively short. The failure monitoring section that performs wireless communication with the above-described failure detection sections may be placed in a mobile object such as an automobile, and the mobile object may move around the units of the photovoltaic power generation system. This makes it easy to deal with a case where the communicable distance of wireless communication is comparatively short.

Furthermore, accumulation of results of the failure detection over a long period of time and analysis of the accumulated data make it possible to recognize, for example, degradation of the units and a change in the environment around the units, and to achieve failure detection suitable for, for example, the degraded units and the changed environment around the units. As to the accumulation of the data, a storage device may be provided on the failure monitoring section side such that the data is accumulated therein to be centrally managed, or alternatively, a memory may be provided in the failure detection sections for accumulating the data therein.

Next, a description will be given of the method of communication between the failure detection sections and the failure monitoring section, taking the structure of the photovoltaic power generation section P1 shown in FIG. 8 as an example.

In the communication method shown in FIG. 9, the failure detection sections 3 and 7 each communicate wirelessly with the failure monitoring section. In the communication method shown in FIG. 10, the failure detection sections 3 and 7 are connected to each other by a information transmission line 8, a result of failure detection by the failure detection section 7 is sent to the failure detection section 3 via the information transmission line 8, and the failure detection section 3 sends, via wireless communication, results of failure detection by the failure detection sections 3 and 7.

Any failure detection section that performs wireless communication generates a signal related to a result of failure detection or a modulation signal thereof, superimposes the thus generated signal on an RF carrier wave to generate an RF signal, and sends the RF signal to the failure monitoring section. Incidentally, it is desirable that, in addition to the signal related to the result of failure detection or the modulation signal thereof, ID information (identification data) or the modulation data thereof be superimposed on the RF carrier wave. This makes it possible for the failure monitoring section that communicates with a failure detection section that performs wireless communication to easily grasp to which unit each result of failure detection corresponds.

In the communication method shown in FIG. 11, the failure detection sections 3 and 7 each communicate with the failure monitoring section via a power line. In the communication method shown in FIG. 12, the failure detection sections 3 and 7 are connected to each other by the information transmission line 8, a result of failure detection by the failure detection section 7 is sent to the failure detection section 3 via the information transmission line 8, and the failure detection section 3 sends results of failure detection by the failure detection sections 3 and 7 to the failure monitoring section via the communication transmission line 8.

Incidentally, the failure detection sections may be arranged such that failure detection can be performed with respect solar cell modules on a module-by-module basis.

FIG. 13 shows an arrangement example in which failure detection sections that perform wireless communication are arranged such that failures of solar cell modules can be detected on a module-by-module basis. In the arrangement example shown in FIG. 13, four cases 11 to 14 each accommodate a failure detection section that performs wireless communication, and each of the cases 11 to 14 incorporates an IC having a voltage application function, a current detection function, and a wireless communication function, and a pattern antenna that is connected to the IC. The case 11 is detachable/attachable at a connection point CN4 with respect to a divergence point DN1 of the first common line C1 included in the first connection cable, and the case 11 is detachable/attachable with respect to a solar cell module M1 at a connection point CN1. The cases 12 and 13 are each detachable/attachable with respect to solar cell modules M1 at connection points CN1. The case 14 is detachable/attachable at a connection point CN5 with respect to a divergence point DN2 of the second common line C2 included in the second connection cable, and the case 14 is detachable/attachable with respect to a solar cell module M1 at a connection point CN1. With this arrangement example, failure detection can be performed with respect to each solar cell modules on a module-by-module basis. Specifically, when the cases 11 and 12 carry out voltage application, failure detection can be carried out with respect to a solar cell module located on the first common line C1 side; when the cases 12 and 13 carry out voltage application, failure detection can be carried out with respect to a solar cell module located in the center; and when the cases 13 and 14 carry out voltage application, failure detection can be carried out with respect to a solar cell module located on the second common line C2 side. By totally evaluating the results of current detection in the cases 11 to 14, failure detection is performed with respect to each unit. The total evaluation of the results of current detection performed in the cases 11 to 14 may be performed by one of the cases that receives current detection results of the other three cases via, for example, an information transmission line (not shown), or may be performed by the failure monitoring section. The present embodiment has dealt with an example in which failure detection can be performed with respect to each individual solar cell module; however, the present invention is obviously applicable to failure detection performed with respect to each individual unit built as a string of a plurality of solar cell modules series-connected to each other.

FIG. 14 shows another arrangement example in which failure detection sections performing wireless communication are arranged such that failures of solar cell modules can be detected on a module-by-module basis. In the arrangement example shown in FIG. 14, three attached bodies 15 to 17 each accommodate a failure detection section that performs wireless communication, and each of the attached body 15 to 17 incorporates an IC having a current generation function to generate current on the side of a solar cell module by electromagnetic induction, a current detection function to detect a current on the side of the solar cell module, and a wireless communication function, and a pattern antenna that is connected to the IC. The attached bodies 15 to 17 are attached to separate solar cell modules. With this arrangement example, failure detection can be performed with respect solar cell modules on a module-by-module basis. Specifically, failure detection can be carried out with respect to a solar cell module located on the first common line C1 side by the attached body 15, failure detection can be carried out with respect to a solar cell module located in the center by the attached body 16, and failure detection can be carried out with respect to a solar cell module located on the second common line C2 side by the attached body 17. By totally evaluating the results of current detection carried out by the attached bodies 15 to 17, failure detection is performed with respect to each unit. The total evaluation of the results of current detection by the attached bodies 15 to 17 may be performed by one of the attached bodies that receives current detection results of the other two attached bodies, via, for example, an information transmission line (not shown), or may be performed by the failure monitoring section.

In still another arrangement example in which failure detection sections performing wireless communication are arranged such that failure detection can be performed with respect to solar cell modules on a module-by-module basis, each solar cell module incorporates an IC and a pattern antenna equivalent to the IC and the pattern antenna, respectively, that are incorporated in the above-described cases or attached bodies. With this arrangement example or with the arrangement example shown in FIG. 14, as long as a power supply is secured for failure detection sections performing wireless communication, even if a solar cell module is stolen, it is possible to track the stolen solar cell module by wireless communication. Likewise, with the arrangement example shown in FIG. 13, if a unit is stolen in a state in which the cases are connected thereto, the stolen unit can be tracked by wireless communication. In the case in which failure detection is performed with respect to the solar cell modules on a module-by-module basis as in the arrangement example in which each solar cell module incorporates the IC and the pattern antenna which are equivalent to the IC and the pattern antenna incorporated in the above-described cases or in the above-described attached bodies and in the arrangement examples shown in FIGS. 13 and 14, it is preferable that ID information (identification data) is also set for each solar cell module.

FIG. 15 shows an arrangement example in which a failure detection section that performs power line communication is connected to both ends of a solar cell module. In the example shown in FIG. 15, a failure detection section performing power line communication includes a current detection section 18 that detects a current that flows in a string and a power line communication modem section 19 that performs transmission of a result of detection performed by the current detection section 18. The power line communication modem section 19 uses output power of a solar cell module M1 as its power, and terminals S+ and S− also function as a power input terminal and a power-line-communication signal output terminal, respectively. A failure detection section performing power line communication is detachable/attachable at a connection point CN6 with respect to a divergence point DN1, which is a first connection section of the first common line C1 included in the first connection cable, and is also detachable/attachable with respect to a solar cell module M1 at a connection point CN1.

Next, FIG. 16 shows another arrangement example in which a failure detection section that performs power line communication is connected to both ends of a solar cell module. In the arrangement example shown in FIG. 16, a failure detection section that performs power line communication includes a current detection section 18, a power line communication modem section 19, a DC/DC conversion transistor 20, and a control section 21 that controls the DC/DC conversion transistor 20. The output voltage of a unit can be changed by being controlled by the control section 21, and this helps reduce restrictions on the input voltage of the inverter device INV1 (see FIG. 1). This is particularly useful in the case in which a high-voltage-output solar cell is used and the number of solar cells series-connected to each other is reduced in a solar cell array, because in such a case, the change in number of solar cells series-connected to each other makes it difficult to adjust the setting of the input voltage of the inverter device INV1. Furthermore, voltage detection is performed at each current detection point, information of the thus detected voltage is exchanged among power line communication modem sections 19, and voltage correction can be performed by using the DC/DC conversion transistor 20 and the control section 21 to cope with reduced solar irradiation caused by a building, a tree, etc. to occur for a certain period of time every day. This leads to improvement of total power generation efficiency of the system. In this case, it is advisable that a DC/DC conversion transistor 20 corresponding to a solar cell module that is suffering from reduced solar irradiation caused by a building, a tree, etc. performs a DC/DC conversion operation, and that a DC/DC conversion transistor 20 corresponding to a solar cell module that is not suffering from reduced solar irradiation caused by a building, a tree, etc. does not perform a DC/DC conversion operation. A failure detection section that is connected to both ends of a solar cell module M1 located on the fist common line C1 side is detachable/attachable at a connection point CN7 with respect to a divergence point DN1 of the first common line C1 included in the first connection cable, and the failure detection section is detachable/attachable at a connection point CN1 with respect to the solar cell module M1 located on the first common line C1 side. A failure detection section that is connected to both ends of a solar cell module M1 located on the second common line C2 side is detachable/attachable at a connection point CN7 with respect to the solar cell module M1 located on the second common line C2 side, and the failure detection section is detachable/attachable at a connection point CN1 with respect to the solar cell module M1 located on the second common line C2 side.

Next, FIG. 17 shows still another arrangement example in which a failure detection section that performs power line communication is connected to both ends of a solar cell module. In the arrangement example shown in FIG. 17, a failure detection section that performs power line communication includes a current detection section 18, a power line communication modem section 19, a DC/AC conversion transistor 22, and a switching control section 23 that controls the turning on/off of the DC/AC conversion transistor 22. The control by the switching control section 23 makes it possible to convert the output voltage of a unit (which is a direct-current voltage) to an alternating-current voltage and to output the alternating-current voltage to between the first common line C1 of the first connection cable and the second common line C2 of the second connection cable. This eliminates the need for the inverter device INV1 (see FIG. 1). In addition, the control by the switching control section 23 makes it possible to control the output state of the unit, and this makes it possible to control the output states of the units on a unit-by-unit basis. Thus, even when part of the units are shaded, control can be appropriately performed. The failure detection section is detachable/attachable at a connection point CN8 with respect to a divergence point DN1 of the first common line C1 included in the first connection cable, and the failure detection section is detachable/attachable at a connection point CN1 with respect to a divergence point DN2 of the second common line C2 included in the second connection cable and with respect to a solar cell module M1.

It should be understood that the present invention is not limited to the foregoing descriptions, and that many other modifications and variations may be made within the scope of the present invention. For example, although the present invention is applied to industrial photovoltaic power generation systems in the above-described embodiments, the application of the present invention is not limited to industrial photovoltaic power generation systems, and the present invention is applicable to household photovoltaic power generation systems. Furthermore, direct-current power generated by a solar cell array may be supplied, without being converted to alternating-current power, to a power network in the vicinity of the area where the power is generated.

### Industrial Applicability

The photovoltaic power generation system according to the present invention is usable as an industrial photovoltaic power generation system and a household photovoltaic power generation system.

### LIST OF REFERENCE SYMBOLS

1 unit

2, 5 divergence section

3, 6, 7 failure detection section

4 blocking diode

8 information transmission line

11-14 case

15-17 attached body

18 current detection section

19 power line communication modem section

20 DC/DC conversion transistor

21 control section

22 DC/AC conversion transistor

23 switching control section

C1, C101 first common line

C2, C102 second common line

CB1 collection box

CN1-CN8 connection point

DN1, DN2 divergence point

INV1 inverter device

JB1-JB14 junction box (having three circuit inputs)

JB101 junction box (having five circuit inputs)

JB102 junction box (having 46 circuit inputs)

JB103 junction box (having two circuit inputs)

M1 solar cell module

M101 low-voltage-output solar cell module

M102 high-voltage-output solar cell module

P1 photovoltaic power generation section

T1 transformer

1. A photovoltaic power generation system, comprising:
a plurality of units, each of the units being formed with a string, which is a series-connection body of a plurality of solar cell modules, or with a solar cell module;
a plurality of connection cables to which the units are each connected such that the units are parallelly connected to each other;
a junction box to which each end of the plurality of connection cables is connected; and
a failure detection section that performs failure detection and outputs a detection result on a unit-by-unit basis,
wherein the failure detection section is located outside the junction box.

2. The photovoltaic power generation system of claim 1,
wherein
one of the plurality of connection cables is a first connection cable provided with a first common line to which one end of each of the plurality of units is connected;
another of the plurality of connection cables is a second connection cable provided with a second common line to which another end of each of the units is connected; and
the failure detection section is located between a first connection section and a second connection section, the first connection section being a section at which a unit of the units is connected to the first common line, and the second connection section being a section at which a unit of the units is connected to the second common line.

3. The photovoltaic power generation system of claim 2, wherein a blocking diode is provided between the first common line and a unit of the units.

4. The photovoltaic power generation system of claim 3, further comprising:
a divergence section that diverges from the first common line to be connected to one end of a unit of the units,
wherein
the blocking diode is arranged in the divergence section.

5. The photovoltaic power generation system of claim 2, further comprising:
a divergence section that diverges from the first common line to be connected to one end of a unit of the units,
wherein
the failure detection section is arranged in the divergence section.

6. The photovoltaic power generation system of claim 4, wherein at least part of the divergence section is replaceable.

7. The photovoltaic power generation system of claim 5, wherein at least part of the divergence section is replaceable.
